(19) United States
(12) Patent Application Publication
(10) Pub. No.: US 2023/0098039 A1
(43) Pub. Date: Mar. 30, 2023

(54) ELECTRICALLY TUNABLE NON-RECIPROCAL PHASE SHIFTER AND POLARIZATION FILTER

(71) Applicants: Chongqing Institute of East China Normal University, Chongqing (CN); East China Normal University, Shanghai (CN); Chongqing Huapu New Energy Co.,Ltd., Chongqing (CN); Chongqing Huapu Information Technology Co.,Ltd., Chongqing (CN); ROI Optoelectronics Technology CO, LTD., Shanghai (CN); Yunnan Huapu Quantum Material Co., Ltd, Kunming (CN); Nanjing ROI Optoelectronics Technology Co.,Ltd., Jiangsu (CN)

(72) Inventors: Heping ZENG, Chongqing (CN); Tingting LIU, Chongqing (CN); Zhengru GUO, Chongqing (CN)

(21) Appl. No.: 17/936,443

(22) Filed: Sep. 29, 2022

(30) Foreign Application Priority Data
Sep. 29, 2021 (CN) 202111148789.1

(51) Int. Cl. H01S 3/08; G02B 27/28; H01S 3/10; G02F 1/21

(52) U.S. Cl. CPC H01S 3/08036; G02B 27/288; H01S 3/10053; H01S 3/08086; G02F 1/211

(57) ABSTRACT

An electrically tunable non-reciprocal phase shifter, an electrically tunable polarization filter, a NALM mode-locked laser and a Sagnac loop are provided. The electrically tunable non-reciprocal phase shifter includes a modulation crystal device, a birefringent crystal device, a Faraday rotator, and a fiber coupler. The phase shifter is configured to couple two beams of light to a fast axis and a slow axis of the modulation crystal device, respectively; and change a refractive index difference between the fast axis and the slow axis to introduce different phase delays for the two beams of the light, so as to control a non-reciprocal linear phase shift amount between the two beams of the light.

### CROSS-REFERENCE TO RELATED APPLICATION

This application claims priority to and benefits of Chinese Patent Application No. 202111148789.1, filed on Sep. 29, 2021, the entire disclosure of which is incorporated herein by reference.

### FIELD

The present disclosure relates to a laser technical field, and more particularly to an electrically tunable non-reciprocal phase shifter, a polarization filter, a NALM mode-locked laser and a Sagnac loop.

### BACKGROUND

In recent years, the waveguide-based ultrafast fiber lasers have become popular due to their excellent stability, compact structure and reasonable price. The ultrafast fiber lasers are commonly mode-locked by real or artificial saturable absorbers. The lasers mode-locked by the real saturable absorber have good self-starting performance and reproducibility, but with a relaxation time in an order of picosecond (ps), which will introduce large noise to pulse. Nonlinear polarization rotation (NPR) and nonlinear amplifying loop mirror (NALM) are commonly used real saturable absorber mode-locked mechanisms. The NPR mode-locking relies on the nonlinear polarization evolution in an optical fiber, and is implemented with a non-polarization-maintaining structure, which has poor environmental adaptability since it is sensitive to external environmental temperature and vibration. By contrast, a polarization-maintaining fiber laser mode-locked by NALM has fast optical response, anti-environmental interference, long-term stability and low noise. Therefore, the NALM mode-locked laser is used in many industrial applications, especially in vehicles and space-borne environments.

### SUMMARY

Embodiments of the present disclosure seek to solve at least one of the problems existing in the related art to at least some extent.

In a first aspect, a wavelength-tunable Lyot filter is provided. The wavelength-tunable Lyot filter includes a modulation crystal device having fast and slow axes, and a total-reflection mirror. A refractive index difference between the fast and slow axes of the modulation crystal device is changed by modulating a magnitude of a voltage applied on the modulation crystal device so as to change phase delay amounts and positions of transmission peaks of the filter to tune a central wavelength of the filter.

In some embodiments, the total-reflection mirror is configured to reflect light from the modulation crystal device.

In some embodiments, the modulation crystal device is a potassium dihydrogen phosphate (KDP) crystal, a lithium niobate (LiNbO₃) crystal, a gallium arsenide (GaAs) crystal, a lithium tantalate (LiTaO₃) crystal, or a combination thereof.

In some embodiments, the wavelength-tunable Lyot filter is configured to output dual-wavelength light or multi-wavelength light.

In some embodiments, the modulation crystal device is a LiNbO₃ crystal device, a refractive index ellipsoid of the modulation crystal device is rotated through 45° along z-axis in a principal axis coordinate system by applying a voltage on x-axis of the modulation crystal device, incident light is divided into two orthogonally polarized components on the fast axis and the slow axis of the modulation crystal device, and the phase delay of the polarized components is generated due to different refractive indices in the modulation crystal device.

In a second aspect, a nonlinear polarization rotation (NPR) laser is provided. The nonlinear polarization rotation (NPR) laser includes the wavelength-tunable Lyot filter according to the first aspect, the wavelength-tunable Lyot filter is located in an optical comb produced by the NPR laser, and configured as a phase-locked element for locking a repetition frequency signal fᵣ or a carrier-envelope offset signal f₀.

In some embodiments, the wavelength-tunable Lyot filter is configured to change an overall refractive index of the modulation crystal device by applying the voltage on the modulation crystal device to change an effective optical path of a single beam of light, and lock a repetition frequency of the NPR laser; and couple a polarization component of the single beam of light into each of the fast axis and the slow axis of the modulation crystal device, and modulate a polarization state of the single beam of light by applying the voltage on the modulation crystal device to change a phase delay amount of the polarization component.

In some embodiments, the NPR laser further includes a resonator, where the modulation crystal device is located. A repetition frequency of the resonator is locked by changing an effective cavity length of the resonator in combined with a phase-locked loop, the effective cavity length of the resonator is modulated by applying a voltage on the resonator to continuously tune the repetition frequency of the resonator.

In a third aspect, an electrically tunable non-reciprocal phase shifter is provided. The electrically tunable non-reciprocal phase shifter includes a birefringent crystal device, a Faraday rotator, a modulation crystal device and a fiber coupler. The phase shifter is configured to couple two beams of light to a fast axis and a slow axis of the modulation crystal device, respectively, and change a refractive index difference between the fast axis and the slow axis to introduce different phase delays for the two beams of the light, so as to control a non-reciprocal linear phase shift amount between the two beams of the light.

In some embodiments, the modulation crystal device includes a potassium dihydrogen phosphate (KDP) crystal, a lithium niobate (LiNbO₃) crystal, a gallium arsenide (GaAs) crystal, a lithium tantalate (LiTaO₃) crystal, or a combination thereof.

In some embodiments, when the modulation crystal device is a LiNbO₃ crystal device, a refractive index ellipsoid of the modulation crystal device is rotated through 45° along a z-axis in a principal axis coordinate system by applying a voltage on an x-axis of the modulation crystal device.

In some embodiments, when a DC voltage is applied, a fixed non-reciprocal linear phase difference is provided to form a fixed phase shifter. When an AC voltage is applied, an adjustable non-reciprocal linear phase difference is provided to form an adjustable phase shifter.

In some embodiments, the birefringent crystal device is selected from a polarizing beam splitter (PBS), a calcite crystal device, a Wollaston prism, or a combination thereof.

In some embodiments, the Faraday rotator is configured to rotate a polarization state of light through 45° to make the light incident along the fast or slow axis of the modulation crystal device.

In a fourth aspect, a nonlinear amplifying loop mirror (NALM) mode-locked laser is provided. The NALM mode-locked laser includes the electrically tunable non-reciprocal phase shifter according to the third aspect. The electrically tunable non-reciprocal phase shifter is configured as a phase-locked element for locking a repetition frequency signal fᵣ or a carrier-envelope offset signal f₀, and configured to provide adjustable non-reciprocal linear phase shift for two beams of light that transmit in forward and reverse directions in a nonlinear loop, so as to implement mode-locking of the laser.

In a fifth aspect, a Sagnac loop is provided. The Sagnac loop includes the electrically tunable non-reciprocal phase shifter according to the third aspect. The electrically tunable non-reciprocal phase shifter is used in the Sagnac loop to provide electrically-controlled adjustable non-reciprocal linear phase shift for two beams of light that transmit in forward and reverse directions to change output characteristics of the Sagnac loop.

In some embodiments, a Sagnac laser is actively mode-locked by changing a voltage applied on the electrically tunable non-reciprocal phase shifter.

In some embodiments, when a DC voltage is applied on the electrically tunable non-reciprocal phase shifter, a fixed non-reciprocal linear phase shift amount is provided. When an AC voltage is applied on the electrically tunable non-reciprocal phase shifter, an adjustable non-reciprocal linear phase shift amount is provided. The electrically tunable non-reciprocal phase shifter is configured as a phase-locked element of a Sagnac laser to lock a repetition frequency signal fᵣ.

### BRIEF DESCRIPTION OF THE DRAWINGS

FIG. 1A is a schematic diagram showing an electrically tunable phase shifter in an embodiment of the present disclosure.

FIG. 1B is a schematic diagram showing another electrically tunable phase shifter in an embodiment of the present disclosure.

FIG. 2 is a schematic diagram showing a NALM mode-locked ultra-short pulse laser constructed by an electronically-controlled tunable phase shifter in an embodiment of the present disclosure.

FIG. 3 is a flow chart of constructing a NALM mode-locked all-fiber optical comb by an electronically-controlled tunable phase shifter in an embodiment of the present disclosure.

FIG. 4A is a schematic diagram showing a figure-of-eight laser cavity of a NALM mode-locked laser in an embodiment of the present disclosure.

FIG. 4B is a schematic diagram showing a figure-of-nine laser cavity of a NALM mode-locked laser in an embodiment of the present disclosure.

FIG. 4C is a schematic diagram showing a relationship between cavity loss and an accumulated phase difference of a NALM mode-locked laser in an embodiment of the present disclosure.

FIG. 4D is a schematic diagram showing a relationship between cavity loss and an accumulated phase difference of a NALM mode-locked laser in another embodiment of the present disclosure.

FIG. 5 is a spectrogram of a NALM mode-locked all-fiber optical comb constructed by an electronically-controlled tunable phase shifter in an embodiment of the present disclosure.

FIG. 6 is a schematic diagram showing a wavelength-tunable Lyot filter in an embodiment of the present disclosure.

FIG. 7 is a schematic diagram showing a NALM mode-locked pulsed laser constructed by a wavelength-tunable Lyot filter in an embodiment of the present disclosure.

### DETAILED DESCRIPTION

In order to make the technical means, technical features, objects and effects achieved by embodiments of the present disclosure easy to understand, the following embodiments with reference to accompanying drawings are used to describe principles, structures, use manners and effects of an electronically-controlled tunable non-reciprocal phase shifter, a polarization filter, a NALM mode-locked laser and a Sagnac loop in an embodiment of the present disclosure.

The NLAM mode-locked laser generally relies on an interference mode locking of two beams of light, and generally has two types of cavity structures, that is, figure-of-eight laser cavity and figure-of-nine laser cavity. The NALM mode-locked laser has a nonlinear part and a linear part that are connected by a beam splitter, and its transmittance is determined by a cumulative phase difference of two beams of light that transmit oppositely in a nonlinear loop. In the figure-of-eight laser cavity, when a phase shift of two beams of light is accumulated to an odd multiple of π, a cavity loss is the smallest, and mode locking is the easiest to achieve. In the figure-of-nine laser cavity, a phase shift needs to reach an even multiple of π. A total phase shift amount of two beams of light is φₜₒₜₐₗ=φ_{L}+φ_{NL}, where φ_{L} is a non-reciprocal linear phase shift amount, and φ_{NL} is an accumulated nonlinear phase shift amount induced by a high-power pulse. In order to obtain a required phase difference between two beams of light that transmit oppositely, it is a common method to provide a non-reciprocal linear phase shift difference for the two beams of light that transmit oppositely, thereby obtaining a NALM fully polarization-maintaining laser with lower mode-locking threshold, more compact structure, and better long-term stability. The current common method is to provide a phase shifter composed of a birefringent crystal device, a wave plate and a Faraday rotator in a resonator, or to use birefringent crystal devices with different lengths, so as to provide a non-reciprocal linear phase shift amount. The above-mentioned methods can only provide a fixed non-reciprocal linear phase difference, and cannot quickly tune the non-reciprocal linear phase shift amount based on artificially controllable external variables, which cannot meet requirements for the laser adjustability. Therefore, on this basis, there is a need to develop a phase shifter that provides a fast tunable non-reciprocal linear phase shift difference for two beams of light to obtain a flexibly adjustable NALM mode-locked laser, thereby realizing precise phase-locking of fᵣ signal, such that the NALM mode-locked laser may be further used for subsequent practical applications, such as an all-fiber optical comb with lower noise and a higher signal-to-noise ratio, and a high-contrast optical comb.

In addition, in recent years, in order to further simplify a structure of a laser and reduce cost, a variety of new all-fiber filter structures are proposed to improve spectral filtering characteristics in a cavity and realize multi-wavelength fiber lasers at room temperature. A Lyot filter has attracted attention due to its simple structure, reasonable price, and all-fiber structure. The Lyot filter is composed of a series of birefringent crystal devices and polarizers, and the transmittance of the Lyot filter depends on wavelength. A beam of light is divided into two orthogonal polarization components, and the two polarization components will produce different phase delays under different refractive indices. The phase delay depends on wavelength, and exhibits different transmittances in the polarizer, thereby achieving a purpose of optical filtering. However, the current Lyot filter is composed of a polarizer and a birefringent crystal device with a fixed refractive index difference between a fast axis and a slow axis, so that the current Lyot filter may only be used as an optical filter for a specific wavelength, and its output spectral width cannot be changed. When other wavelengths are meant to be filtered, the Lyot filter needs to be replaced, which is time-consuming, labor-intensive and expensive. Therefore, there is a need to develop a Lyot filter with a tunable central wavelength, an adjustable output spectral width and other characteristics. On this basis, it is of great significance to develop a laser with multi-wavelength output and tunable output wavelength. Furthermore, it is possible to develop an all-fiber dual-optical comb by using the laser with tunable output wavelength as a laser light source, and further develop a phase-locked element by using the wavelength-tunable Lyot filter to lock a repetition frequency signal fᵣ or a carrier-envelope offset signal f₀.

In order to solve the problems existing in the related art, the present disclosure provides an electrically tunable non-reciprocal phase shifter, a polarization filter, a NALM mode-locked laser and a Sagnac loop. According to the present disclosure, by coupling two beams of light to a fast axis and a slow axis of a modulation crystal device, and applying a voltage on the modulation crystal device to modulate a refractive index difference between the fast axis and the slow axis of the modulation crystal device, different phase delays may be introduced between the fast axis and the slow axis, thereby introducing a fast tunable non-reciprocal linear phase difference to the two beams of light or tuning an output wavelength of a Lyot filter.

It should be noted that the electronically-controlled tunable non-reciprocal phase shifter and the wavelength-tunable Lyot filter provided in embodiments of the present disclosure are configured to modulate the refractive index difference between the fast axis and the slow axis of the modulation crystal device by applying the voltage, and they have various implementation structures and may be applied in different scenarios according to actual needs. The implementation structures and corresponding application scenarios include but are not limited to the following items.

(1) The modulation crystal device may be selected from a potassium dihydrogen phosphate (KDP) crystal, a lithium niobate (LiNbO₃) crystal, a gallium arsenide (GaAs) crystal, a lithium tantalate (LiTaO₃) crystal, or a combination thereof.

(2) The modulation by applying the voltage may be transverse modulation or longitudinal modulation.

(3) For a single beam of light, a single modulation crystal device may be used, and its refractive index may be changed by applying a voltage to change an effective optical path.

(4) According to item (3), the modulation crystal device may be located in a resonator, and a repetition frequency signal fᵣ of the resonator may be locked precisely by changing an effective cavity length of the resonator in combined with a phase-locked loop.

(5) According to item (4), the effective cavity length of the resonator may be modulated by applying a voltage on the resonator, so as to continuously tune the repetition frequency of the resonator.

(6) For two beams of light, a single birefringent crystal device may be used, and the two beams of light are coupled into a fast axis and a slow axis of the birefringent crystal device respectively. Delays of the two beams of light may be modulated by changing the refractive index difference between the fast axis and the slow axis by applying the voltage.

(7) According to item (6), the phase shifter may be used to adjust pulse delay, such as for f-2f self-reference detection of an optical comb to detect a carrier-envelope offset signal f₀.

(8) The modulation crystal device may be combined with the birefringent crystal device to separate a polarization state of a beam of light into two polarization states, and the two polarization states are coupled into the fast axis and the slow axis of the modulation crystal device, respectively. The two polarization states are combined into a beam after undergoing different time delays. By changing the applied voltage, different polarization states may be output.

(9) According to item (8), the birefringent crystal device may be a polarizing beam splitter (PBS), a calcite crystal device, or a Wollaston prism.

(10) According to item (8), a polarization state evolution inside a polarization controller is based on a fast electro-optic effect, and the output polarization state may be precisely controlled by the applied voltage, which may realize fast and large-scale tuning of the output polarization state.

(11) According to item (8), the Lyot filter may be used in a nonlinear polarization rotation (NPR) laser, and mode-locking of the laser may be realized based on the fast-tunable polarization state evolution.

(12) According to item (11), the Lyot filter may be used in an optical comb produced by the NPR mode-locked laser, and configured as a phase-locked element for locking a repetition frequency signal fᵣ or a carrier-envelope offset signal f₀ precisely.

(13) The modulation crystal device may be combined with the polarizer, such that a beam of light is divided into two orthogonal polarization components. The two polarization components are coupled into the fast axis and the slow axis of the modulation crystal device to obtain different phase delays. Relative phase shifts of the two polarization components are related to wavelengths. By modulating a voltage applied on the modulation crystal device, the refractive index difference between the fast axis and the slow axis is changed, and the phase delay amount between wavelengths may be changed to obtain different transmittances according to the different phase delay amounts, such that a wavelength-tunable Lyot filter may be obtained.

(14) According to item (13), when the applied voltage of the modulation crystal device is changed, the height of the peak and the spectral width of an output wavelength will be changed accordingly. In this way, output characteristics of the Lyot filter may be precisely controlled by applying a voltage, thereby obtaining a large tuning range.

(15) According to item (13), the wavelength-tunable Lyot filter may be used for multi-wavelength output.

(16) According to item (15), the wavelength-tunable Lyot filter is used in a laser, such that a laser may output two or more repetition frequency signals fᵣ, and an amount of the repetition frequency may be controlled by applying the voltage to the modulation crystal device.

(17) According to item (16), a laser that outputs two repetition frequency signals fᵣ may be used as a laser light source to produce a dual-optical comb.

(18) A modulation crystal device may be combined with a birefringent crystal device, a Faraday rotator, and a fiber coupler to form an electrically tunable non-reciprocal phase shifter. The phase shifter is configured to couple two beams of light to a fast axis and a slow axis of the modulation crystal device, respectively; and change a refractive index difference between the fast axis and the slow axis to introduce different phase delays for the two beams of light, so as to control a non-reciprocal linear phase shift amount between the two beams of light.

(19) According to item (18), the phase shifter may have a space structure or a fiber-coupled integrated package structure.

(20) According to item (18), different effects may be produced depending on different types of the applied voltage. When a DC voltage is applied, a fixed non-reciprocal linear phase difference is provided to form a fixed phase shifter. When an AC voltage is applied, an adjustable non-reciprocal linear phase difference is provided to form an adjustable phase shifter.

(21) According to item (20), the fixed phase shifter may be combined with the adjustable phase shifter to increase a range of the non-reciprocal linear phase shift amount.

(22) According to item (18), when a LiNbO₃ crystal is used as the electro-optical modulation crystal device, a refractive index ellipsoid of the modulation crystal device automatically rotates through 45° along a z-axis by applying a voltage on an x-axis of the modulation crystal device without manual adjustment and calibration of an optical axis angle, which is simple and accurate.

(23) According to item (22), it is possible to greatly reduce angle adjustment and coupling difficulty between the elements, reduce light loss, and avoid additional problems caused by artificial angle errors.

(24) According to item (22), a waveguide structure based on the LiNbO₃ crystal may be used as the modulation crystal device, which reduces coupling of light, and it is possible to obtain an all-fiber electronically-controlled tunable phase shifter with a low half-wave voltage and a low power consumption.

(25) According to item (18), the phase shifter may be used in various scenarios that require phase difference adjustments, such as in a Sagnac interferometer, a nonlinear optical loop mirror (NOLM) and a NALM mode-locked laser.

(26) According to item (18), the phase shifter may be used in the NALM mode-locked laser to provide adjustable non-reciprocal linear phase shift for two beams of light that transmit in forward and reverse directions in a nonlinear loop, to help phase accumulation and implement mode-locking of the laser.

(27) According to item (26), the phase shifter may effectively reduce a mode-locking threshold and power consumption of the NALM resonator, and enhance self-starting performance of the NALM resonator.

(28) According to item (26), an all-fiber optical comb based on NALM mode-locking may be provided, which has a compact structure, anti-environmental interference, a long-term stability, and may be used in extreme environments such as rocket-borne and space-borne environments.

(29) According to item (28), the electronically-controlled tunable phase shifter may be configured as a phase-locked element for locking a repetition frequency signal fᵣ or a carrier-envelope offset signal f₀ precisely.

(30) According to items (18) and (26), the non-reciprocal linear phase shift amount provided by the electronically-controlled tunable phase shifter may be changed by applying a voltage to increase a linear cavity loss, such that a larger nonlinear phase shift amount φ_{NL} of the two beams of light that transmit oppositely needs to be accumulated to achieve mode-locking. The sufficient phase difference accumulation can only be achieved by relying on a central position of pulse with higher power, while edges and sub-central positions of the pulse are lost. Therefore, the resonator may output pulse in the central position, which may significantly suppress pulse noise and improve the optical comb signal contrast.

(31) According to item (25), the electrically tunable phase shifter in an embodiment of the present disclosure may be used in a Sagnac loop to provide an electrically tunable non-reciprocal linear phase shift for two beams of light that transmit in opposite directions, and to change output characteristics of the Sagnac loop.

(32) According to item (31), the phase shifter may be used in other fields based on Sagnac effect, such as a fiber Sagnac loop filter, a Sagnac type fiber optic hydrophone and so on.

(33) According to item (31), the Sagnac laser may be actively mode-locked by changing a voltage applied on the electrically tunable non-reciprocal phase shifter by means of phase modulation mode locking.

(34) According to item (31), in the Sagnac loop equipped with the electrically tunable phase shifter, when a DC voltage is applied on the electrically tunable non-reciprocal phase shifter, a fixed non-reciprocal linear phase shift amount is provided. When an AC voltage is applied on the electrically tunable non-reciprocal phase shifter, an adjustable non-reciprocal linear phase shift amount is provided.

(35) According to item (33), the electrically tunable phase shifter in an embodiment of the present disclosure may be configured as a phase-locked element of the Sagnac laser to lock a repetition frequency signal fᵣ.

(36) According to item (33), an all-fiber active mode-locked optical comb based on the Sagnac laser may be provided, which has a compact structure and good long-term stability.

(37) According to item (36), the electrically tunable phase shifter in an embodiment of the present disclosure may be configured as a phase-locked element for locking a carrier-envelope offset signal f₀ of the actively mode-locked optical comb precisely.

The above are some applications of the electronically-controlled non-reciprocal tunable phase shifter in an embodiment of the present disclosure, and the electronically-controlled non-reciprocal tunable phase shifter may be applied to other specific application scenarios by changing its implementation structure according to actual needs.

In an embodiment of the present disclosure, the electrically tunable non-reciprocal linear phase difference for the two beams of light are provided, and the NALM mode-locked laser and the resulting all-fiber optical comb are used as the application scenarios for explanation. The electronically-controlled tunable phase shifter is configured inside the NALM resonator, which may contribute to the phase accumulation of the two beams of light that transmit in opposite directions in a nonlinear loop, and effectively reduce its mode-locking threshold and enhance the self-starting performance of the laser. The all-fiber optical comb may be obtained by using the NALM mode-locked resonator equipped with the electrically tunable phase shifter as the laser light source. By changing the voltage applied on the phase shifter, a linear loss of the resonator may be increased, such that the resonator outputs pulse through a most central position, which may suppress noise in the pulse, thereby obtaining the fiber optical comb with low noise and a high signal-to-noise ratio. In addition, the phase shifter in an embodiment of the present disclosure may be configured as the phase-locked element for locking the repetition frequency signal fᵣ or the carrier-envelope offset signal f₀ precisely, thereby obtaining the laser and the optical-comb with high accuracy and high stability.

By changing the voltage applied to the modulation crystal device, the refractive index difference between the fast axis and the slow axis of the modulation crystal device may be changed, thereby changing the phase delay amount between different wavelengths. Since different transmittances correspond to different phase delay amounts, the wavelength-tunable Lyot filter may be obtained. In addition, by modulating the applied voltage, the peak height and width of the output spectrum of the Lyot filter will be changed accordingly, thereby precisely controlling the output characteristics of the laser. Furthermore, the wavelength-tunable Lyot filter in an embodiment of the present disclosure may output dual wavelengths or even multiple wavelengths, and thus the Lyot filter may be used as the laser light source to produce the all-fiber optical comb, which may be used as a dual-optical comb, and a frequency value of the repetition frequency signal fᵣ may be controlled by the applied voltage. In addition, the wavelength-tunable Lyot filter in an embodiment of the present disclosure may be configured as the phase-locked element for locking the repetition frequency signal fᵣ or the carrier-envelope offset signal f₀ precisely.

In some embodiments of the present disclosure, an electrically tunable phase shifter including a Wollaston prism, a LiNbO₃ crystal, a Faraday rotator and a total-reflection mirror is provided, which may provide a tunable non-reciprocal linear phase shift difference for two beams of light. An ultrashort pulse laser based on NALM mode-locking and its derived all-fiber optical comb are provided to illustrate application scenarios of the phase shifter. A wavelength-tunable Lyot filter including a LiNbO₃ crystal is provided, and an ultrashort pulse laser based on NALM mode-locking and its derived all-fiber optical comb are provided to illustrate application scenarios of the filter.

The LiNbO₃ crystal belongs to an electro-optical crystal. In an anisotropic medium, refractive index in each direction is different, such that the light propagation speed of each polarization state is different. In general, a refractive index ellipsoid is used to describe a relationship between the refractive index and the propagation direction of light, and that between the refractive index and vibration direction of light. In a principal axis coordinate system, the refractive index ellipsoid equation is

$$\frac{{x}^{2}}{{n}_{x}^{2}} + \frac{{y}^{2}}{{n}_{y}^{2}} + \frac{{z}^{2}}{{n}_{z}^{2}} = 1 ,$$

where nₓ is a refractive index of an x-axis of the ellipsoid, n_{y} is a refractive index of a y-axis of the ellipsoid, and n_{z} is a refractive index of a z-axis of the ellipsoid. After an electric field is applied to the crystal, shape, size and orientation of the refractive index ellipsoid change, and the ellipsoid equation becomes

$$\frac{{x}^{2}}{{n}_{xx}^{2}} + \frac{{y}^{2}}{{n}_{yy}^{2}} + \frac{{z}^{2}}{{n}_{zz}^{2}} + \frac{2 yz}{{n}_{yz}^{2}} + \frac{2 xz}{{n}_{xz}^{2}} + \frac{2 xy}{{n}_{xy}^{2}} = 1 ,$$

where the cross term is caused by the electric field. The LiNbO₃ crystal is a uniaxial negative crystal, and meet nₓ=n_{y}=nₒ and n₂=nₑ. When the electric field is applied in the x-axis direction and light propagates along the z-axis direction, the crystal changes from a uniaxial crystal to a biaxial crystal, and a section of the refractive index ellipsoid perpendicular to the z-axis direction changes from a circle to an ellipse. The ellipse equation is

$$( \frac{1}{{n}_{0}^{3}} - {γ}_{yy} {E}_{x} ) {x}^{2} + ( \frac{1}{{n}_{0}^{2}} + {γ}_{yy} {E}_{x} ) {y}^{2} - 2 {γ}_{yy} {E}_{x} xy = 1.$$

When the principal axis is transformed and n₀²Y_{yy}Eₓ<<1, after simplify,

$${n}_{x}^{′} = {n}_{o} + \frac{1}{2} {n}_{o}^{3} {γ}_{yy} {E}_{x} and {n}_{y}^{′} = {n}_{0} - \frac{1}{2} {n}_{o}^{3} {γ}_{yy} {E}_{x}$$

are obtained. When the electric field is applied in the x-axis direction, a new refractive index ellipsoid is formed by rotating 45° around the z-axis without manual adjustment of an optical axis angle, which reduces the light loss and angle deviation. In short, when the electric field is applied, the refractive index of the LiNbO₃ crystal and the refractive index difference between the axes will change accordingly.

The electrically tunable phase shifter includes the Wollaston prism, the LiNbO₃ crystal, the Faraday rotator and the total-reflection mirror. The LiNbO₃ crystal has a slow axis with a refractive index of n₁, and a fast axis with a refractive index of n₂. A beam of light that transmits in a forward direction passes through a birefringent crystal device, and then passes through the Faraday rotator, such that a polarization state of the light is rotated by 45° to make the light incident along the fast axis of the electro-optical modulation crystal device. The light is reflected by the total-reflection mirror, and passes through the fast axis of the electro-optical modulation crystal device and the Faraday rotator again, such that the polarization state is rotated by 90° totally, and the light exits from the other axis of the birefringent crystal device. An accumulated phase delay φ1 of the light passing through the fast axis of the electro-optical modulation crystal device twice is obtained. Similarly, a beam of light that transmits in a reserve direction passes through the birefringent crystal device, and then passes through the Faraday rotator, such that a polarization state of the light is rotated by 45° to make the light incident along the slow axis of the electro-optical modulation crystal device. The light is reflected by the total-reflection mirror, and passes through the slow axis of the electro-optical modulation crystal device and the Faraday rotator again, such that the polarization state is rotated by 90° totally, and the light exits from the other axis of the birefringent crystal device. An accumulated phase delay φ2 of the light passing through the slow axis of the electro-optical modulation crystal device twice is obtained. Thus, a non-reciprocal linear phase shift difference between the two beams of light passing through the phase shifter may be as follows:

$$Δφ = \vert {φ}_{1} - {φ}_{2} \vert = \frac{4 π}{{λ}_{0}} \vert {n}_{1} - {n}_{2} \vert l = \frac{4 π}{{λ}_{0}} \vert {n}_{x}^{′} - {n}_{y}^{′} \vert l = \frac{4 π}{{λ}_{0}} {n}_{o}^{3} {γ}_{yy} \frac{l}{d} ( {V}_{0} + {V}_{m} sin 2 π ft ) ,$$

where λ₀ is a laser central wavelength, l is a length of the electro-optical modulation crystal device, d is a thickness of the electro-optical modulation crystal device, and f is a modulation frequency of the applied alternating electric field. By adjusting the voltage applied on the electro-optical modulation crystal device, Δn=n₁−n₂ may be changed, and thus the non-reciprocal linear phase delay between the two counter-propagating pulses may be precisely controlled. It can be seen from the above formula that when a DC voltage is applied, a fixed phase difference may be generated, and when an AC voltage with a frequency off is applied, a periodically changing phase difference may be generated. That is, different phase delays may be achieved according to different applied voltages, such that the phase shifter may be suitable for different application scenarios.

As a practical application scenario, an ultrashort pulse laser based on NALM mode-locking is provided, which includes a 976 nm pump source, a wavelength division multiplexer, an erbium-doped gain fiber, an electrically tunable phase shifter, a fiber splitter and a fiber mirror that are connected in sequence in an optical path. The connections among the 976 nm pump source, the wavelength division multiplexer, the electrically tunable phase shifter, the fiber beam splitter and the fiber mirror are implemented by pigtail fusion coupling. The fiber splitter and the fiber mirror constitute a linear arm of the NALM cavity, and other elements constitute a nonlinear loop of the NALM cavity. In the nonlinear loop, a beam of light from the 976 nm pump source is coupled to a common port through a pump port of the wavelength division multiplexer, and gathered with a signal light to inject into the erbium-doped gain fiber, thereby generating 1550 nm laser after being stimulated. The fiber splitter is located at a connection position of the nonlinear loop and the linear arm, and is configured to couple the laser in the nonlinear loop into the linear arm. The laser in the linear arm is totally reflected by the optical fiber mirror and is split into two beams of light that transmit in clockwise and counterclockwise directions in the nonlinear loop. After the two counterpropagating beams of light pass through the electronically-controlled tunable phase shifter, a non-reciprocal linear phase shift will be generated between the two beams of light, and the phase shift amount may be precisely controlled by the applied voltage. After the total phase shift amount reaches a state where the cavity loss is minimized, the laser is mode-locked.

The all-fiber optical frequency comb based on the NALM mode-locked laser mainly includes five parts: an ultrafast laser light source, an optical amplifier, a supercontinuum broadening device, a f-2f self-reference beat frequency detection device and a phase-locked loop. The ultrafast laser light source is configured to output a mode-locked seed pulse, and pulse energy of the seed pulse is increased from an order of pJ to an order of nJ by the optical amplifier. A polarization-maintaining single-mode fiber is used to compensate for excessive positive dispersion introduced by the amplifier, so as to compress the pulse width to less than 100 fs and increase the corresponding pulse peak power to an order of kilowatt, thereby obtaining a high-power ultrashort pulse. The high-power ultrashort pulse is directly injected into the supercontinuum broadening device, and a series of nonlinear effects induced by the high-power ultrashort pulse are used to expand the output spectrum to cover an octave. The f-2f self-reference beat frequency device is used to measure a carrier-envelope offset signal f₀. Finally, two negative feedback phase-locking loops are used for precisely controlling the fᵣ and f₀ signals by feeding back the corresponding error signals to the phase-locking elements in the cavity, thereby obtaining a stable optical comb. In principle, in a figure-of-nine laser cavity based on NALM mode locking, a phase difference between the two beams of light that transmit in opposite directions needs to reach 2π, while the cavity loss is minimal, so that mode-locking may be achieved. If the linear cavity loss is increased through modulating a voltage applied on the electrically tunable phase shifter, a larger nonlinear phase shift φNL of the two beams of light that transmit oppositely is needed to achieve mode-locking. The nonlinear phase shift is accumulated based on nonlinear effects induced by high power, so a larger nonlinear phase shift corresponds to higher power. Thus, the central position of the pulse with higher power may be selected to achieve sufficient phase accumulation, and the power on the pulse edges and sub-central position will be lost. In this way, the resonator may output the pulse at the most central position, which may significantly suppress pulse noise and improve the signal to noise ratio (SNR) of the optical comb.

A wavelength-tunable Lyot filter includes a LiNbO₃ crystal and a total-reflection mirror. After a voltage is applied to the LiNbO₃ crystal, its refractive index ellipsoid will rotate by 45° along z-axis, and an incident beam will be divided into two orthogonally polarized components on a fast axis and a slow axis of the LiNbO₃ crystal. The polarized components will have different phase delay amounts after experiencing different refractive indices, and the phase delay amount is related to wavelength. The beam goes through the LiNbO₃ crystal is reflected by the total-reflection mirror, and then returns to the LiNbO₃ crystal to experience a further phase delay. Finally, according to the different phase delay amounts, the light exhibits different transmittances at the output port, such that light with specific wavelength is transmitted, while the others are lost, thereby achieving a filtering effect. By modulating the voltage applied on the LiNbO₃ crystal, the refractive index difference between the fast axis and the slow axis of the LiNbO₃ crystal may be changed, such that the phase delay amount is changed, and a position of a transmission peak of the Lyot filter is thus changed, so as to tune a central wavelength of the Lyot filter. In addition, the peak height and spectral width of the transmitted wavelength of the Lyot filter may be precisely controlled by the applied voltage.

Further, wavelengths that satisfy a specific phase delay difference may transmit the Lyot filter. Therefore, the wavelength-tunable Lyot filter according to an embodiment of the present disclosure may output dual-wavelength or multi-wavelength pulses. In other words, a laser may output multiple repetition frequency signals fᵣ and thus an all-fiber double-comb may be developed, and the frequency of the repetition frequency signal fᵣ may be precisely controlled by the applied voltage. In addition, the wavelength-tunable Lyot filter in an embodiment of the present disclosure may be further configured as the phase-locked element for locking the repetition frequency signal fᵣ or the carrier-envelope offset signal f₀ precisely.

In some embodiments of the present disclosure, the specific implementation structures and application scenarios may be selected as actual needs. A variety of implementation structures may be derived, which may be applied to a variety of practical scenarios with high practical value.

In some embodiments of the present disclosure, the central wavelength-tunable Lyot filter is provided, and the height of the output peak, the output spectral width and other characteristics of the Lyot filter may be controlled by the applied voltage.

In some embodiments of the present disclosure, the Lyot filter that outputs multi-wavelength pulses is provided, which may be used as a laser light source to provide a dual-comb system.

In some embodiments of the present disclosure, the adjustable non-reciprocal linear phase shift may be provided for two beams of light that transmit in forward and reverse directions, and the magnitude of the phase shift may be precisely controlled by the applied voltage, which solves a problem of the fixed and unadjustable phase difference, and increases the flexibility and practicability of the phase shifter.

In some embodiments of the present disclosure, the LiNbO₃ crystal is used as an electro-optical modulation crystal device. When an electric field is applied, the refractive index ellipsoid automatically rotates through 45° along the z-axis without manual adjustment and calibration, with high angular accuracy and easy coupling.

In some embodiments of the present disclosure, an all-fiber coupling and packaging may be realized, with a high degree of integration.

In some embodiments of the present disclosure, ultra-short pulse lasers based on NALM mode locking may be provided, which effectively decreases the mode locking threshold of the NALM, and provides NALM-based lasers with high integration, high stability and low cost.

In some embodiments of the present disclosure, an all-fiber optical comb based on NALM mode locking may be provided, which significantly improves the contrast ratio of the optical comb signal, and provides an optical comb with low noise, high signal-to-noise ratio and high stability.

In some embodiments of the present disclosure, the phase shifter may be configured as a phase-locked element for locking the repetition frequency signal fᵣ or the carrier-envelope offset signal f₀, and configured to significantly improve the locking accuracy of the signal and reduces the noise of the optical comb.

In some embodiments, the NALM mode-locking optical comb based on the phase shifter is implemented with a full polarization-maintaining fiber structure, which has a small size, high practical value, and strong environmental adaptability, and may be used in field or in a space-borne environment.

In an embodiment of the present disclosure, the phase shifter may be used for multiple purposes, which has high integration, good flexibility, and a wide range of practical applications.

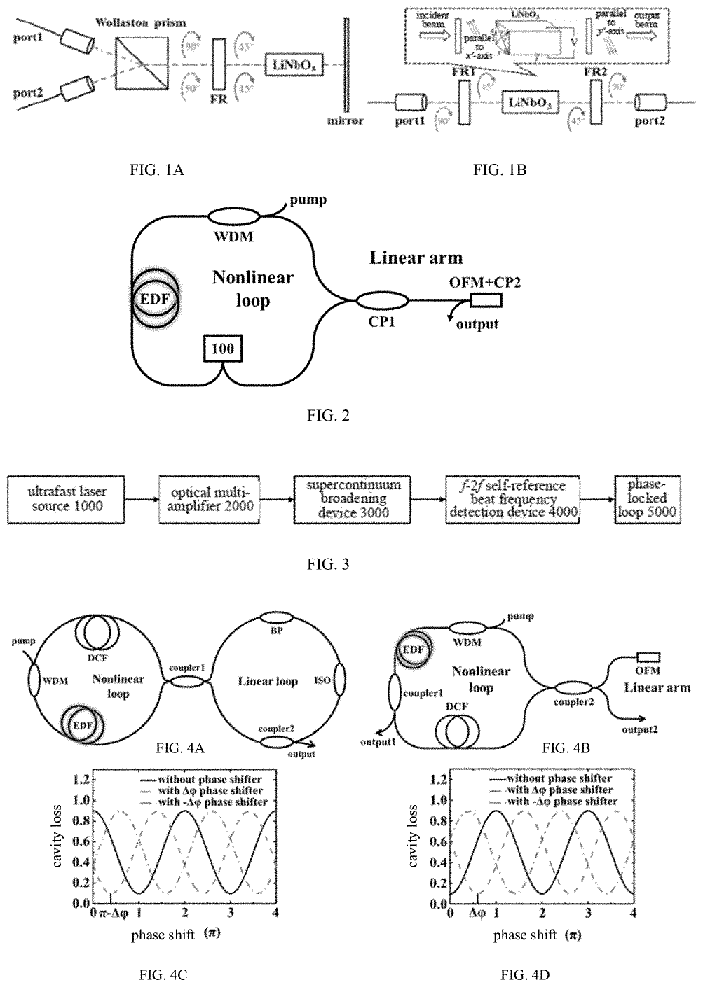

FIG. 1A is a schematic diagram showing an electrically tunable phase shifter in an embodiment of the present disclosure. As shown in FIG. 1A, the electrically tunable phase shifter includes a first fiber coupling port1 and a second fiber coupling port2, a Wollaston prism, a Faraday rotator FR, a LiNbO₃ crystal and a total-reflection mirror. All the fiber pigtails of port1 and port2 are polarization-maintaining fibers. An incident direction of port1 is along an o-axis of the Wollaston crystal, and an incident direction of port2 is along an e-axis of the Wollaston crystal. In the LiNbO₃ crystal, a length is represented as 1, a thickness is represented as d, a refractive index along a fast axis is represented as n₁, and a refractive index along a slow axis is represented as n₂. A beam of light that transmits in a forward direction enters via port1, transmits along the o-axis of the Wollaston prism, and passes through the Faraday rotator FR, such that a polarization state is rotated by 45° to make the light enter along the fast axis of the LiNbO₃ crystal. The light is reflected by the total-reflection mirror, and passes through the fast axis of the LiNbO₃ crystal and the Faraday rotator FR again, such that the polarization state is rotated by 90°. In this way, the light emerges along the e-axis of the Wollaston prism, is coupled into a fiber at port2, and enters the resonator to continue to propagate. The light passes through the fast axis of the LiNbO₃ crystal twice, and an accumulated phase delay amount is φ₁. Similarly, a beam of light that transmits in a reverse direction enters via port2, transmits along the e-axis of the Wollaston prism and passes through the Faraday rotator FR, such that a polarization state is rotated by 45° to make the light enter along the slow axis of the LiNbO₃ crystal. The light is reflected by the total-reflection mirror, and passes through the slow axis of the LiNbO₃ crystal and the Faraday rotator FR again, such that the polarization state is rotated by 90°. In this way, the light emerges along the o-axis of the Wollaston prism, is coupled into a fiber at port1, and enters the resonator to continue to propagate. After the light passes through the slow axis of the LiNbO₃ crystal twice, an accumulated phase delay amount is φ₂. In this way, after the light passes through the electronically-controlled tunable phase shifter, a non-reciprocal linear phase difference between the beams of light that transmit in the forward and reverse directions is obtained, that is,

$$Δφ = \vert {φ}_{1} - {φ}_{2} \vert = \frac{4 π}{{λ}_{0}} \vert {n}_{1} - {n}_{2} \vert l = \frac{4 π}{{λ}_{0}} \vert {n}_{x}^{′} - {n}_{y}^{′} \vert l = \frac{4 π}{{λ}_{0}} {n}_{o}^{3} {γ}_{yy} \frac{l}{d} ( {V}_{0} + {V}_{m} sin 2 π ft ) ,$$

where λ₀ is a laser central wavelength, l is a length of the electro-optical modulation crystal device, d is a thickness of the electro-optical modulation crystal device, and f is a modulation frequency of the applied alternating electric field. By adjusting the voltage applied on the electro-optical modulation crystal device, a refractive index difference between the fast axis and the slow axis, that is, Δn=n₁−n₂ may be changed, thereby changing the non-reciprocal linear phase difference Δφ, such that the non-reciprocal linear phase shift amount may be manually adjusted and precisely controlled. It can be seen from the above-mentioned formula that when a DC voltage is applied, a fixed phase difference may be generated, and when an AC voltage with a frequency off is applied, a periodically changing phase difference may be generated. In this way, different phase delay may be achieved by applying different voltages, such that the phase shifter may be suitable for different application scenarios.

FIG. 1B is a schematic diagram showing another electrically tunable phase shifter in an embodiment of the present disclosure. As shown in FIG. 1B, the electrically tunable phase shifter includes a first fiber coupling port1 and a second fiber coupling port2, a first Faraday rotator FR1, a second Faraday rotator FR2, and a LiNbO₃ crystal. All the fiber pigtails of port1 and port2 are polarization-maintaining fibers. A beam of light that transmits in a forward direction enters via port1, and passes through the first Faraday rotator FR1, such that a polarization state is rotated by 45°. When a voltage U is applied to the LiNbO₃ crystal, its refractive index ellipsoid will automatically rotate by 45° along an z-axis, that is, the refractive index ellipsoid will rotate from x-axis and y-axis to x′-axis and y′-axis, in which an angle difference between x-axis and x′-axis is 45°, and an angle difference between y-axis and y′-axis is 45°. After passing through FR1, the polarization state of the incident beam is rotated by 45°, which is exactly parallel to x′-axis. Then, the light enters along the fast axis of the LiNbO₃ crystal, and passes through the second Faraday rotator FR2, such that the polarization state is further rotated by 45°, which is parallel to the y′-axis. That is, the polarization state of the output beam and the incident beam differs by 90°. The output beam is coupled into a fiber at port2, and enters the resonator to continue to propagate, and an accumulated phase delay amount is φ₃. A beam of light that transmits in a reverse direction enters via port2, and passes through the second Faraday rotator FR2, such that a polarization state is rotated by 45°, which is parallel to y′-axis. Then, the light enters along the slow axis of the LiNbO₃ crystal, and passes through the first Faraday rotator FR1, such that the polarization state is further rotated by 45°, which is parallel to x′-axis. The light is coupled into a fiber at port1, and enters the resonator to continue to propagate, and an accumulated phase delay amount is φ₄, as shown an inset in FIG. 1B. In this way, anon-reciprocal linear phase difference between the beams of light that transmit in the forward and reverse directions is obtained, that is,

$${Δφ}^{′} = \vert {φ}_{3} - {φ}_{4} \vert = \frac{2 π}{{λ}_{0}} \vert {n}_{1} - {n}_{2} \vert l = \frac{2 π}{{λ}_{0}} \vert {n}_{x}^{′} - {n}_{y}^{′} \vert l = \frac{2 π}{{λ}_{0}} {n}_{o}^{3} {γ}_{yy} \frac{l}{d} ( {V}_{0} + {V}_{m} sin 2 π ft ) ,$$

and the phase shift amount may be precisely controlled by the applied voltage. If a rotation angle is adjusted manually, it is difficult to precisely adjust an optical axis difference between the electro-optical modulation crystal device and the incident light to 45°. However, based on the character of the LiNbO₃ crystal, when a voltage is applied on the LiNbO₃ crystal, its refractive index ellipsoid will be automatically rotated by exactly 45° along z-axis. Therefore, the optical axis difference between the LiNbO₃ crystal and the incident light may reach 45° without manual adjustment, which avoids angle correction error and coupling difficulties caused by manual adjustment, improves angular accuracy, reduces light loss, and improves long-term stability.

As shown in FIG. 2, a NALM mode-locked ultra-short pulse laser based on an electronically-controlled tunable phase shifter 100 is provided, which has a figure-of-nine laser cavity, and includes a 976 nm pump source, a wavelength division multiplexer (WDM), an erbium-doped gain fiber (EDF), the electronically-controlled tunable phase shifter 100, a first fiber beam splitter (CP1) and a composite device (OFM+CP2) which combines an optical fiber mirror and a second optical beam splitter that are connected in sequence in the optical path. The wavelength division multiplexer (WDM), the erbium-doped gain fiber (EDF) and the electronically-controlled tunable phase shifter 100 constitute a nonlinear loop of the NALM cavity. The first fiber beam splitter (CP1) and the composite device (OFM+CP2) constitute a linear arm of the NALM cavity. The connections between all fiber optic components are implemented by pigtail fusion coupling.

A pigtail of the 976 nm pump source is connected to a pump port of the reflective WDM, and pump light is injected into a common port of WDM through reflection. Laser of 1550 nm is transmitted in a core of a fiber, and the pump light of 976 nm is transmitted in a cladding. Then, the common port of WDM is fusion-spliced with EDF. In the EDF fiber, erbium ions first spontaneously radiate a small part of the laser of 1550 nm to transmit in the cavity as signal light, and then are stimulated under induction of the pump light of 976 nm to radiate a large amount of the laser of 1550 nm to transmit in the cavity. A splitting ratio of the first fiber splitter CP1 is 50:50. There are three functions of the first fiber splitter CP1. First, the fiber splitter CP1 may be configured to connect the nonlinear loop and the linear arm. Second, the fiber splitter CP1 may be configured to couple two beams of light that transmit in forward and reverse directions in the nonlinear loop into the linear arm, and separate the laser on the linear arm into two beams of light to inject into the nonlinear loop to form the entire optical resonator. Third, the fiber splitter CP1 may be configured to narrow pulse according to different transmittances presented by accumulated phase shift of the pulse at different positions. For the figure-of-nine laser cavity, when a phase difference between the two beams of light that transmit in forward and reserve directions reaches 2π, the loss in the resonator is minimal, and mode locking is easier to achieve. Since a central portion of the pulse at a central position has relatively high power, more nonlinear effects are caused in the nonlinear loop, the nonlinear phase shift is relatively large, and it is easier for the phase difference to reach 2π. However, since a portion of the pulse at an edge position has low power, it is more difficult for the phase difference to reach 2π. Therefore, the first optical beam splitter CP1 shows a higher reflectivity to the central portion of the pulse. The central portion of the pulse passes through the first optical beam splitter CP1 and is injected into the linear arm. After the pulse is reflected by the fiber mirror, the pulse enters the nonlinear ring again and participates in a next pulse cycle as seed light, so as to narrow the pulse. The laser emergent from the linear arm is split into two pulses by the first fiber beam splitter CP1 that transmit in forward and reverse directions in the nonlinear loop. The counterclockwise laser experiences a phase delay φ₁ at the electronically-controlled tunable phase shifter 100, and the clockwise laser experiences a phase delay φ₂ at the electronically-controlled tunable phase shifter 100. In this way, a non-reciprocal linear phase shift difference is introduced between the two beams of laser that transmit oppositely, that is, Δφ=|φ₁-φ₂|, which may be precisely controlled by the applied voltage. When a sum of the nonlinear phase difference and the non-reciprocal linear phase difference accumulates to 2π, the laser experiences minimal loss, and mode locking is achieved. The composite device is an integrated device of the optical fiber mirror and the second fiber beam splitter CP2. A beam splitting ratio of the second fiber beam splitter CP2 is 20:80, and 20% of the laser is used as an overall output of the laser for subsequent amplification or practical application. The electrically tunable phase shifter 100 is provided in the NALM mode-locked laser, which may effectively reduce the mode-locking threshold of the resonator, reduce cost and power consumption, and improve the self-starting performance of the resonator.

FIG. 3 is a flow chart of constructing an all-fiber optical comb by using the NALM mode-locked laser shown in FIG. 2 as a laser light source. The all-fiber optical comb includes five parts: an ultrafast laser light source 1000, an optical multi-amplifier 2000, a supercontinuum broadening device 3000, a f-2f self-reference beat frequency detection device 4000 and a phase-locked loop 5000. The ultrafast laser light source 1000 is the NALM mode-locked laser shown in FIG. 2, and is configured to output a seed pulse with single-pulse energy in an order of pJ. The energy of the seed pulse is amplified by the optical multi-amplifier 2000 to achieve an average power to more than 100 mW, and increase the pulse energy to an order of nJ. The optical multi-amplifier 2000 is further configured to compensate for excessive positive dispersion introduced by a gain fiber in the amplifier with a segment of PM-1550 with negative dispersion, so as to compress a pulse width to less than 100 fs and the corresponding peak power may achieve kilowatt, thereby obtaining a high-power ultrashort pulse. The high-power ultrashort pulse is directly injected into the supercontinuum broadening device 3000. The supercontinuum broadening device 300 mainly includes a section of high nonlinear fiber PM-HNLF with a nonlinear coefficient of 10.5 W⁻¹km⁻¹. The high-power ultrashort pulse will induce a series of nonlinear effects in the high nonlinear fiber, such as self-phase modulation, cross-phase modulation, four-wave mixing and so on, thereby broadening the output spectral range of the amplifier to 1000 to 2200 nm. After a supercontinuum is obtained, a repetition frequency signal fᵣ and a carrier-envelope offset signal f₀ are detected by the f-2f self-reference beat frequency detection device 4000. The f-2f self-reference beat frequency detection device 4000 may have a collinear structure or a non-collinear structure. Finally, the phase-locked loop 5000 is used to feed back the frequency error between the fᵣ and f₀ signals and the standard reference signals to a phase-locked element in the resonator to achieve simultaneous locking of the two signals and obtain a stable optical comb.

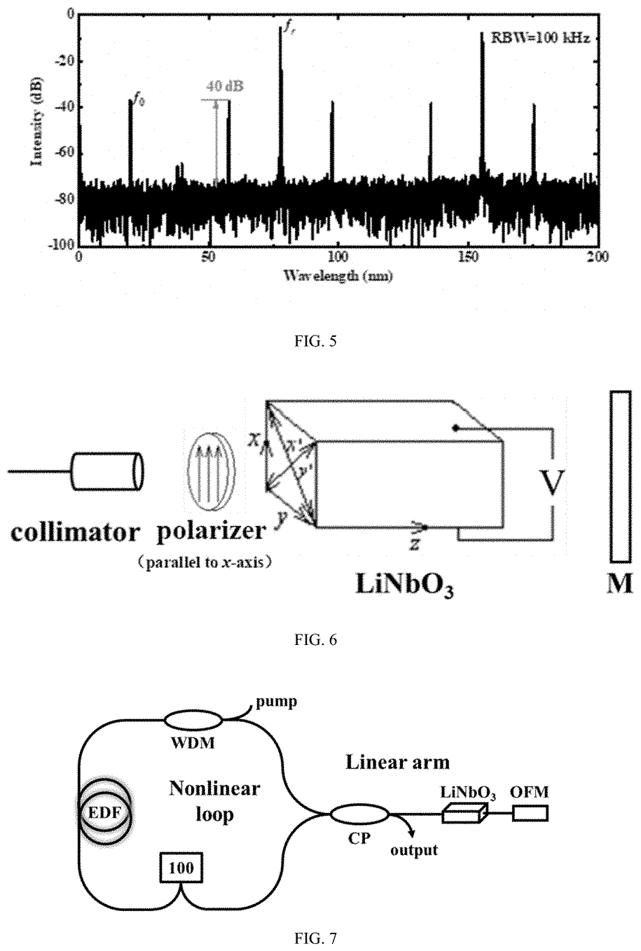

FIGS. 4A-4D are schematic diagrams showing a relationship between cavity loss and an accumulated phase difference of a NALM mode-locked laser. FIG. 4A shows a structure of a figure-of-eight laser cavity of a NALM mode-locked laser, and FIG. 4B shows a structure of a figure-of-nine laser cavity of a NALM mode-locked laser. FIG. 4C shows a relationship between a cavity loss and a total phase difference in a figure-of-eight laser cavity, and FIG. 4D shows a relationship between a cavity loss and a total phase difference in a figure-of-nine laser cavity. It can be seen that for the figure-of-eight laser cavity, when the total phase difference of the two counter-propagating pulses reaches an odd multiple of π, a cavity loss is the smallest, and mode locking is the easiest to achieve. For the figure-of-nine laser cavity, the total phase difference needs to reach an even multiple of π. When a voltage applied on the electrically tunable phase shifter is changed, the non-reciprocal linear phase shift amount of the two counter-propagating pulses may be precisely controlled. When the linear cavity loss increases, in order to achieve a sufficient total phase shift amount, a larger nonlinear phase shift is needed. The nonlinear phase shift generally depends on the nonlinear effects induced by the high power. For pulses, the central portion has the highest power and may induce more nonlinear effects, such as self-phase modulation, cross-phase modulation, stimulated Raman, and four-wave mixing, which may change the phase. Therefore, the largest nonlinear phase shift amount may be obtained in the central portion of the pulse. When the non-reciprocal linear phase shift amount is reduced, the resonator is forced to output the most central position of the pulse, while the edges and sub-central positions of the pulse is lost. Therefore, noise of the pulse may be significantly suppressed, and the signal-to-noise ratio of the optical fiber comb teeth may be improved. FIG. 5 is a signal spectrogram of the all-fiber optical comb based on the NALM mode-locked laser shown in FIG. 2. It can be seen that the signal-to-noise ratio of the f₀ signal exceeds 40 dB, which benefits the development of the all-fiber optical comb with a high stability and a high contrast.

In addition, it should be noted that the f₀ signal of the optical comb is sensitive and is related to each physical parameter in the resonator. When the voltage applied on the electronically-controlled tunable phase shifter is changed, a refractive index of a medium and a pulse evolution process change, and a frequency of the f₀ signal changes accordingly. Therefore, the electronically-controlled tunable phase shifter in an embodiment of the present disclosure may be used as a phase-locked element for locking the f₀ signal.

FIG. 6 is a schematic diagram showing a wavelength-tunable Lyot filter in an embodiment of the present disclosure. As shown in FIG. 6, a beam of light enters from a collimator, and passes through a polarizer, such that a polarization state of light is parallel to an original x-axis of a LiNbO₃ crystal. When a voltage is applied on the LiNbO₃ crystal, its refractive index ellipsoid automatically rotates by 45° along z-axis to form a new x′-axis and a new y′-axis. At this time, the incident light is divided into two orthogonal polarization components on x′-axis and y′-axis. The two orthogonal polarization components have different phase delay amount due to different refractive indices, and the phase delay amount is related to the wavelength. The laser emergent from the LiNbO₃ crystal is reflected by a total-reflection mirror to return to the LiNbO₃ crystal along the original path, so as to make the light experience another phase delay. The light at different wavelengths is selectively transmitted in the polarizer according to the phase delay amount, and finally is coupled into the collimator to continue to transmit in the resonator. When the laser returns to the polarizer, the transmittance depends on the wavelength. By calculating based on a Jones matrix method, a Jones matrix of the transmitted light may be considered as a simple product of a deviation angle Jones matrix, a birefringent crystal device Jones matrix and a total-reflection mirror Jones matrix. After simplification, by bring the deviation angle θ=45°, a transmitted light expression of the Lyot filter may be obtained as T=1−cos²(2πBl/λ), where l is a length of the modulation crystal device, and B=|n_{x′}−n_{y′}|, and thus

$$T = 1 - {cos}^{2} ( 2 π Bl / λ ) = 1 - {cos}^{2} ( \frac{2 π}{λ} \vert {n}_{{x}^{′}} - {n}_{{y}^{′}} \vert l ) .$$

When the voltage applied on the LiNbO₃ crystal is changed, |n_{x′}−n_{y′}| will change, and the transmittance will change accordingly. In other words, by changing the voltage applied on the LiNbO₃ crystal, a position of a transmission peak of the Lyot filter may be changed, thereby tuning the central wavelength. In addition, when the transmittance is controlled by the applied voltage, the height of the output peak and the output spectral width of the Lyot filter will change accordingly.

FIG. 7 is a schematic diagram showing a NALM mode-locked pulsed laser based on a wavelength-tunable Lyot filter. As shown in FIG. 7, the Lyot filter adapts a LiNbO₃ crystal as a waveguide structure to form an all-fiber structure, and the all-fiber structure is placed on a linear arm of the NALM mode-locked laser, which has a small half-wave voltage and a large tunable range.

Similar to FIG. 2, by using the electrically tunable phase shifter 100, two beams of light transmit oppositely in the nonlinear loop to obtain a sufficient phase difference, and reflected onto the linear arm by an optical beam splitter CP. The optical beam splitter CP is a polarization maintaining device whose slow axis works and fast axis is cut off, and has a beam splitting ratio of 50:50. Therefore, the optical beam splitter CP may be used as a polarizer. A linear polarized light transmitted along the slow axis is transmitted to the LiNbO₃ waveguide through the polarization maintaining fiber, and the polarization direction of the light is parallel to the original x-axis of the LiNbO₃ waveguide. When a voltage is applied to the LiNbO₃ waveguide, its refractive index ellipsoid automatically rotates by 45° along z-axis to form a new coordinate system of x′-axis and y′-axis. The linear polarized light is divided into two orthogonal polarization components on x′-axis and y′-axis to experience different phase delay amounts, and the phase delay amount depends on wavelength. The laser is reflected by the optical fiber mirror OFM to return to the optical beam splitter CP through the LiNbO₃ waveguide. Since the optical beam splitter CP works on the slow axis, light with specific wavelengths may be selectively transmitted according to different phase delay differences. In an embodiment of the present disclosure, the central wavelength may be tuned without change of the crystal or repeated coupling, which is simple and convenient, and easy to integrate. The LiNbO₃ waveguide has a low half-wave voltage and a low power consumption. In addition, the height of the output spectral peak and the spectral width of the laser may be modulated by the applied voltage. It can be seen from the expression that the transmittance varies periodically with the refractive index difference between the fast axis and the slow axis of the LiNbO₃ waveguide. Therefore, the Lyot filter has more than one transmittance peak and may output dual-wavelength or even multi-wavelength light. For dual-wavelength output, one laser may output two fᵣ signals since the wavelength-dependent refractive index of the medium, thus, the effective optical path is different. As can be seen in FIG. 3, the laser is used as the laser light source to generate the all-fiber optical comb, a dual optical comb may be obtained, and the frequency value of the fᵣ signal may be controlled by the applied voltage. In addition, the wavelength-tunable Lyot filter in an embodiment of the present disclosure may also be used as the phase-locked element for locking the fᵣ or f₀ signal. By feeding back the error signal to the applied voltage of the filter, the fᵣ signal or the f₀ signal may be precisely phase-locked. In this way, the device may have multiple functions with high integration and strong flexibility, and different modulation signals may be loaded according to actual needs to achieve different purposes, which may be applied to a variety of practical scenarios.

In a first aspect, a wavelength-tunable Lyot filter is provided. The wavelength-tunable Lyot filter includes a modulation crystal device, and a total-reflection mirror. A refractive index difference between a fast axis and a slow axis of the modulation crystal device is changed by modulating a magnitude of a voltage applied on the modulation crystal device so as to change a phase delay amount and a position of a transmission peak of the filter to tune a central wavelength of the filter.

In some embodiments, the modulation of the voltage is transverse modulation or longitudinal modulation.

In some embodiments, the modulation crystal device is selected from a potassium dihydrogen phosphate (KDP) crystal, a lithium niobate (LiNbO₃) crystal, a gallium arsenide (GaAs) crystal, a lithium tantalate (LiTaO₃) crystal, or a combination thereof.

In some embodiments, the wavelength-tunable Lyot filter is configured to apply the voltage on the modulation crystal device to change an overall refractive index of the modulation crystal device to change an effective optical path of a single beam of light, and lock a repetition frequency of a laser; and couple a polarization component of the single beam of light into each of the fast axis and the slow axis of the modulation crystal device, and modulate a polarization state of the single beam of light by applying the voltage on the modulation crystal device to change a phase delay amount of the polarization component.

In some embodiments, a wavelength of a laser is determined by changing the refractive index difference, changing the phase delay amount, and changing transmittance of the laser.

In some embodiments, the wavelength-tunable Lyot filter is configured to output dual-wavelength light or multi-wavelength light.

In some embodiments, the modulation crystal device is located in a resonator. A repetition frequency of the resonator is locked by changing an effective cavity length of the resonator in combined with a phase-locked loop. The effective cavity length of the resonator is modulated by applying a voltage on the resonator to continuously tune the repetition frequency of the resonator.

In a second aspect, a nonlinear polarization rotation (NPR) laser is provided. The nonlinear polarization rotation (NPR) laser includes the wavelength-tunable Lyot filter according to the first aspect. The NPR laser is mode-locked by adjusting polarization state evolution; the wavelength-tunable Lyot filter is located in an optical comb produced by the NPR laser, and configured as a phase-locked element for locking a repetition frequency signal fᵣ or a carrier-envelope offset signal f₀.

In a third aspect, an electrically tunable non-reciprocal phase shifter is provided. The electrically tunable non-reciprocal phase shifter includes a modulation crystal device; a birefringent crystal device; a Faraday rotator; and a fiber coupler. The electrically tunable non-reciprocal phase shifter is configured to: couple two beams of light to a fast axis and a slow axis of the modulation crystal device, respectively; change a refractive index difference between the fast axis and the slow axis to introduce different phase delays for the two beams of the light, so as to control a non-reciprocal linear phase shift amount between the two beams of the light.

In some embodiments, the electrically tunable non-reciprocal phase shifter has a space structure or a fiber-coupled integrated package structure.

In some embodiments, when a DC voltage is applied, a fixed non-reciprocal linear phase difference is provided to form a fixed phase shifter. When an AC voltage is applied, an adjustable non-reciprocal linear phase difference is provided to form an adjustable phase shifter.

In some embodiments, the fixed phase shifter is combined with the adjustable phase shifter to increase a range of the non-reciprocal linear phase shift amount. The modulation crystal device has a waveguide structure of LiNbO₃ to form an all-fiber electronically-controlled adjustable phase shifter.

In a fourth aspect, a nonlinear amplifying loop mirror (NALM) mode-locked laser is provided. The NALM mode-locked laser includes the electrically tunable non-reciprocal phase shifter according to the third aspect. The electrically tunable non-reciprocal phase shifter is configured as a phase-locked element for locking a repetition frequency signal fᵣ or a carrier-envelope offset signal f₀, and configured to provide adjustable non-reciprocal linear phase shift for two beams of light that transmit in forward and reverse directions in a nonlinear loop, so as to implement mode-locking of the laser.

In a fifth aspect, a Sagnac loop is provided. The Sagnac loop includes the electrically tunable non-reciprocal phase shifter according to the third aspect. The electrically tunable non-reciprocal phase shifter is used in the Sagnac loop to provide electrically-controlled adjustable non-reciprocal linear phase shift for two beams of light that transmit in forward and reverse directions to change output characteristics of the Sagnac loop.

In some embodiments, a Sagnac laser is actively mode-locked by changing a voltage applied on the electrically tunable non-reciprocal phase shifter.

In some embodiments, when a DC voltage is applied on the electrically tunable non-reciprocal phase shifter, a fixed non-reciprocal linear phase shift amount is provided. When an AC voltage is applied on the electrically tunable non-reciprocal phase shifter, an adjustable non-reciprocal linear phase shift amount is provided. The electrically tunable non-reciprocal phase shifter is configured as a phase-locked element of a Sagnac laser to lock a repetition frequency signal fᵣ.

Finally, it is noted that the above-mentioned embodiments are only used to explain the technical solution of the present disclosure and shall not be construed as limitation. Despite detailed description is made for the present disclosure with reference to the aforementioned embodiments, those skilled in the art should understand that they may make modifications to the technical solutions recited in the foregoing embodiments or equivalent replacements of part of the technical features, and these modifications or replacements will not make the essential of the corresponding technical solution depart from the spirit and scope of the technical solution in respective embodiments of the present disclosure.

What is claimed is:

1. A wavelength-tunable Lyot filter, comprising:
a modulation crystal device having fast and slow axes; and
a total-reflection mirror;
wherein a refractive index difference between the fast and slow axes of the modulation crystal device is changed by modulating a magnitude of a voltage applied on the modulation crystal device so as to change phase delay amounts and positions of transmission peaks of the filter to tune a central wavelength of the filter.

2. The wavelength-tunable Lyot filter according to claim 1, wherein the total-reflection mirror is configured to reflect light from the modulation crystal device.

3. The wavelength-tunable Lyot filter according to claim 1, wherein the modulation crystal device is a potassium dihydrogen phosphate (KDP) crystal, a lithium niobate (LiNbO₃) crystal, a gallium arsenide (GaAs) crystal, a lithium tantalate (LiTaO₃) crystal, or a combination thereof.

4. The wavelength-tunable Lyot filter according to claim 1, configured to output dual-wavelength light or multi-wavelength light.

5. The wavelength-tunable Lyot filter according to claim 1, wherein the modulation crystal device is a LiNbO₃ crystal device, a refractive index ellipsoid of the modulation crystal device is rotated through 45° along z-axis in a principal axis coordinate system by applying a voltage on x-axis of the modulation crystal device, incident light is divided into two orthogonally polarized components on the fast axis and the slow axis of the modulation crystal device, and the phase delay of the polarized components is generated due to different refractive indices in the modulation crystal device.

6. A nonlinear polarization rotation (NPR) laser comprising the wavelength-tunable Lyot filter according to claim 1, wherein the wavelength-tunable Lyot filter is located in an optical comb produced by the NPR laser, and configured as a phase-locked element for locking a repetition frequency signal fᵣ or a carrier-envelope offset signal f₀.

7. The NPR laser according to claim 6, wherein the wavelength-tunable Lyot filter is configured to:
change an overall refractive index of the modulation crystal device by applying the voltage on the modulation crystal device to change an effective optical path of a single beam of light, and lock a repetition frequency of the NPR laser; and
couple a polarization component of the single beam of light into each of the fast axis and the slow axis of the modulation crystal device, and modulate a polarization state of the single beam of light by applying the voltage on the modulation crystal device to change a phase delay amount of the polarization component.

8. The NPR laser according to claim 6, further comprising:
a resonator, where the modulation crystal device is located;
wherein a repetition frequency of the resonator is locked by changing an effective cavity length of the resonator in combined with a phase-locked loop; and
the effective cavity length of the resonator is modulated by applying a voltage on the resonator to continuously tune the repetition frequency of the resonator.

9. An electrically tunable non-reciprocal phase shifter, comprising:
a birefringent crystal device;
a Faraday rotator;
a modulation crystal device; and
a fiber coupler,
wherein the phase shifter is configured to:
couple two beams of light to a fast axis and a slow axis of the modulation crystal device, respectively; and
change a refractive index difference between the fast axis and the slow axis to introduce different phase delays for the two beams of the light, so as to control a non-reciprocal linear phase shift amount between the two beams of the light.

10. The phase shifter according to claim 9, wherein the modulation crystal device comprises a potassium dihydrogen phosphate (KDP) crystal, a lithium niobate (LiNbO₃) crystal, a gallium arsenide (GaAs) crystal, a lithium tantalate (LiTaO₃) crystal, or a combination thereof.

11. The phase shifter according to claim 9, wherein the modulation crystal device is a LiNbO₃ crystal device, a refractive index ellipsoid of the modulation crystal device is rotated through 45° along a z-axis in a principal axis coordinate system by applying a voltage on an x-axis of the modulation crystal device.

12. The phase shifter according to claim 9, wherein:
when a DC voltage is applied, a fixed non-reciprocal linear phase difference is provided to form a fixed phase shifter; and
when an AC voltage is applied, an adjustable non-reciprocal linear phase difference is provided to form an adjustable phase shifter.

13. The phase shifter according to claim 9, wherein the birefringent crystal device is selected from a polarizing beam splitter (PBS), a calcite crystal device, a Wollaston prism, or a combination thereof.

14. The phase shifter according to claim 9, wherein the Faraday rotator is configured to rotate a polarization state of light through 45° to make the light incident along the fast or slow axis of the modulation crystal device.

15. A nonlinear amplifying loop mirror (NALM) mode-locked laser comprising the electrically tunable non-reciprocal phase shifter according to claim 9, wherein the phase shifter is configured as a phase-locked element for locking a repetition frequency signal fᵣ or a carrier-envelope offset signal f₀, and configured to provide adjustable non-reciprocal linear phase shift for two beams of light that transmit in forward and reverse directions in a nonlinear loop, so as to implement mode-locking of the laser.

16. A Sagnac loop comprising the electrically tunable non-reciprocal phase shifter according to claim 9, wherein the electrically tunable non-reciprocal phase shifter is used in the Sagnac loop to provide electrically-controlled adjustable non-reciprocal linear phase shift for two beams of light that transmit in forward and reverse directions to change output characteristics of the Sagnac loop.

17. The Sagnac loop according to claim 16, wherein a Sagnac laser is actively mode-locked by changing a voltage applied on the electrically tunable non-reciprocal phase shifter.

18. The Sagnac loop according to claim 16, wherein:
when a DC voltage is applied on the electrically tunable non-reciprocal phase shifter, a fixed non-reciprocal linear phase shift amount is provided;
when an AC voltage is applied on the electrically tunable non-reciprocal phase shifter, an adjustable non-reciprocal linear phase shift amount is provided; and
the electrically tunable non-reciprocal phase shifter is configured as a phase-locked element of a Sagnac laser to lock a repetition frequency signal fᵣ.
